(19) United States
(12) Patent Application Publication
(10) Pub. No.: US 2025/0253969 A1
(43) Pub. Date: Aug. 7, 2025

(54) METHOD AND APPARATUS FOR CONTROLLING DATA TRANSMISSION RATE BASED ON DPU, AND DATA PROCESSING UNIT

(71) Applicant: Beijing Volcano Engine Technology Co., Ltd., Beijing (CN)

(72) Inventors: Shoujing BO, Beijing (CN); Jiali JIANG, Beijing (CN); Tao LIU, Beijing (CN); Qianqian PENG, Beijing (CN); Yaobao WANG, Beijing (CN); Bin WANG, Beijing (CN); Jian WANG, Beijing (CN)

(21) Appl. No.: 19/041,129

(22) Filed: Jan. 30, 2025

(30) Foreign Application Priority Data
Feb. 1, 2024 (CN) 202410145219.4

(51) Int. Cl. H04L 1/00

(52) U.S. Cl. CPC H04L 1/0002

(57) ABSTRACT

The present disclosure relates to a method and apparatus for controlling a data transmission rate based on a DPU, and a data processing unit. The method includes: receiving data traffic fed back by a storage cluster on the basis of an initial data read request, where the initial data read request is transmitted by a processor to the storage cluster at a first moment at an initial transmission rate; detecting reliability indicator data corresponding to the data traffic; analyzing the reliability indicator data to obtain a target adjustment strategy corresponding to the initial transmission rate; and adjusting the initial transmission rate based on the target adjustment strategy to obtain a target transmission rate, so that the processor transmits a data read request to the storage cluster at the target transmission rate at a second moment, where the second moment is a next moment of the first moment.

### CROSS-REFERENCE TO RELATED APPLICATION(S)

This application claims priority to Chinese Application No. 202410145219.4 filed Feb. 1, 2024, the disclosure of which is incorporated herein by reference in its entirety.

### FIELD

The present disclosure relates to the field of communication technologies and, in particular, to a method and apparatus for controlling a data transmission rate based on a DPU, and a data processing unit.

### BACKGROUND

Block storage plays a very important role in the development of cloud computing. With the evolution of services, a data processing unit (abbreviated as DPU) is particularly important as a hardware virtualization base.

### SUMMARY

In view of this, the embodiments of the present disclosure provide a method and apparatus for controlling a data transmission rate based on a DPU, and a data processing unit, so as to solve the problem that the rate of outputting data traffic by a storage cluster can be reduced only by using a TCP flow control method, but the pressure on the storage cluster cannot be relieved, resulting in the performance of the storage cluster not meeting the expectation.

In a first aspect, an embodiment of the present disclosure provides a method for controlling a data transmission rate based on a DPU. The method includes:
detecting data traffic received by the DPU, where the DPU is configured to transmit an initial data read request to a storage cluster at a first moment at an initial transmission rate, and the data traffic is fed back by the storage cluster to the DPU after the initial data read request is received (S11);
detecting reliability indicator data corresponding to the data traffic (S12);
analyzing the reliability indicator data to obtain a target adjustment strategy corresponding to the initial transmission rate (S13); and
adjusting the initial transmission rate based on the target adjustment strategy to obtain a target transmission rate, to cause the DPU to transmit a data read request to the storage cluster at the target transmission rate at a second moment, where the second moment is a next moment of the first moment (S14).

In a second aspect, an embodiment of the present disclosure provides an apparatus for controlling a data transmission rate based on a DPU. The apparatus includes:
a receiving module configured to detect data traffic received by the DPU, where the DPU is configured to transmit an initial data read request to a storage cluster at a first moment at an initial transmission rate, and the data traffic is fed back by the storage cluster to the DPU after the initial data read request is received;
a detecting module configured to detect reliability indicator data corresponding to the data traffic;
an analyzing module configured to analyze the reliability indicator data to obtain a target adjustment strategy corresponding to the initial transmission rate; and
an adjusting module configured to adjust the initial transmission rate based on the target adjustment strategy to obtain a target transmission rate, to cause the DPU to transmit a data read request to the storage cluster at the target transmission rate at a second moment, where the second moment is a next moment of the first moment.

In a third aspect, an embodiment of the present disclosure provides a data processing unit. The data processing unit includes a system on chip and a field programmable gate array. The system on chip is connected to the field programmable gate array through a bus. The field programmable gate array includes a rate adapter and a regulator.

The system on chip is configured to generate a data read request, and pass the data read request to the rate adapter in the field programmable gate array through the bus.

The rate adapter is configured to transmit the data read request to a storage cluster at an initial transmission rate at a first moment.

The regulator is configured to: receive a data traffic fed back by the storage cluster on the basis of the initial data read request; detect reliability indicator data corresponding to the data traffic; analyze the reliability indicator data to obtain a target adjustment strategy corresponding to the initial transmission rate; and adjust the initial transmission rate based on the target adjustment strategy to obtain a target transmission rate, so that the data processing unit transmits a data read request to the storage cluster at the target transmission rate at a second moment, where the second moment is a next moment of the first moment.

In a fourth aspect, an embodiment of the present disclosure provides an electronic device. The electronic device includes a memory and a processor. The memory and the processor communicate with each other. The memory stores computer instructions. The processor executes the computer instructions to perform the method according to the first aspect or any one of the implementations corresponding to the first aspect.

In a fifth aspect, an embodiment of the present disclosure provides a computer-readable storage medium. The computer-readable storage medium stores computer instructions. The computer instructions are used to enable a computer to perform the method according to the first aspect or any one of the implementations corresponding to the first aspect.

### BRIEF DESCRIPTION OF THE DRAWINGS

In order to more clearly illustrate the technical solutions in the specific embodiments of the present disclosure or in the prior art, the following briefly introduces the drawings that need to be used in the description of the specific embodiments or the prior art. Apparently, the drawings in the following description show some embodiments of the present disclosure, and persons of ordinary skill in the art may still derive other drawings from these drawings without creative efforts.

FIG. 1 is a flowchart of a method for controlling a transmission rate of a data request according to some embodiments of the present disclosure;

FIG. 2 is a schematic diagram of interaction between a processor and a storage cluster according to some embodiments of the present disclosure;

FIG. 3 is a block diagram of an apparatus for controlling a transmission rate of a data request according to an embodiment of the present disclosure;

FIG. 4 is a block diagram of a structure of a processor according to an embodiment of the present disclosure; and

FIG. 5 is a schematic diagram of a hardware structure of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described hereunder clearly and comprehensively with reference to the drawings in the embodiments of the present disclosure. Apparently, the described embodiments are merely some rather than all of the embodiments of the present disclosure. All other embodiments obtained by persons of ordinary skill in the art based on the embodiments of the present disclosure without creative efforts shall fall within the protection scope of the present disclosure.

According to the embodiments of the present disclosure, a method and apparatus for controlling a data transmission rate based on a DPU, and a data processing unit are provided. It should be noted that the steps shown in the flowcharts may be executed in a computer system such as a set of computer-executable instructions. In addition, although a logical order is shown in the flowcharts, the steps shown or described may be executed in an order different from that herein in some cases.

Block storage plays a very important role in the development of cloud computing. With the evolution of services, a data processing unit (abbreviated as DPU) is particularly important as a hardware virtualization base. The DPU has many requirements for storage performance. However, storage traffic is bursty, which results in significant packet loss at end nodes of the DPU and highly unstable performance.

Currently, a common practice is that a storage cluster uses a TCP flow control solution to avoid congestion and packet loss. A congestion control algorithm of the TCP performs congestion control on data traffic output by the storage cluster. For example, in the case of packet loss in the storage cluster, a TCP flow control method can only reduce the rate of the data traffic output by the storage cluster, but cannot relieve the pressure on the storage cluster, so that the performance of the storage cluster does not meet the expectation.

In the method provided in the embodiment of the present disclosure, the reliability indicator data of the data traffic fed back by the storage cluster on the basis of the data read request is detected, the adjustment strategy is determined according to the reliability indicator data, and the rate of transmitting the data read request to the storage cluster at the next moment is finally adjusted according to the adjustment strategy. In this way, the rate of transmitting the data read request by the processor is dynamically adjusted according to the reliability indicator data, thereby avoiding network congestion. In addition, the rate of outputting the data traffic by the storage cluster can be indirectly controlled, thereby further ensuring the storage performance of the storage cluster.

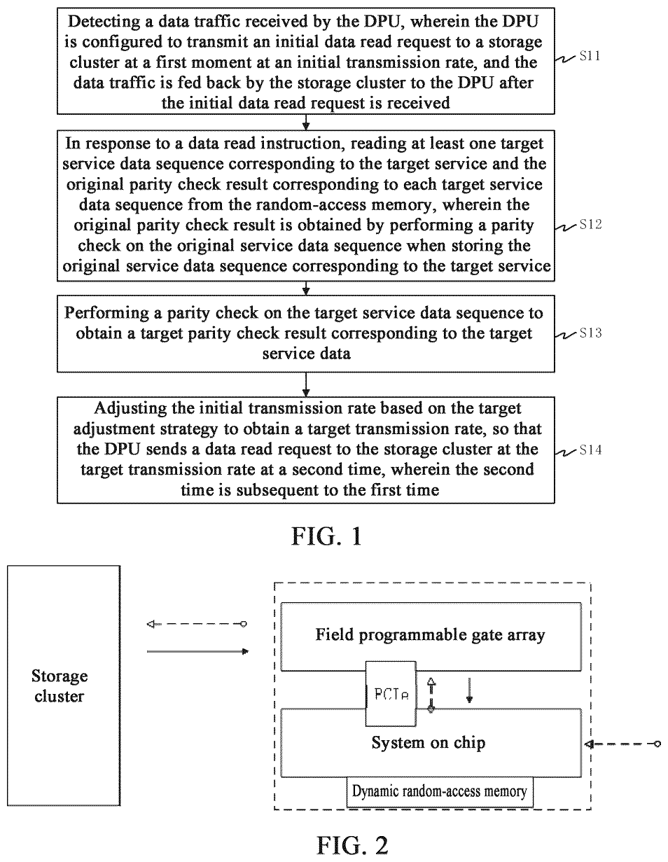

The embodiments provide a method for controlling a data transmission rate based on a DPU. FIG. 1 is a flowchart of a method for controlling a data transmission rate based on a DPU according to an embodiment of the present disclosure. As shown in FIG. 1, the method includes steps described below.

In S11, data traffic received by the DPU is detected, where the DPU is configured to transmit an initial data read request to a storage cluster at a first moment at an initial transmission rate, and the data traffic is fed back by the storage cluster to the DPU after the initial data read request is received.

The method provided in the embodiment of the present disclosure is applied to a processor, and the processor referred to in the embodiment of the present disclosure may be a data processing unit (abbreviated as DPU). The DPU may transmit an initial data read request to a storage cluster at an initial transmission rate at a first moment, where the initial data read request is used to request to obtain a data traffic corresponding to a service corresponding to the DPU. The service corresponding to the DPU may be a data analysis and processing service, for example, big data analysis, machine learning, etc. In this case, the data traffic may include various image and video files, such as a real-time video stream of a surveillance camera, a medical image, etc. The service corresponding to the DPU may be a network optimization service, for example, network acceleration, etc. In this case, the data traffic may include network traffic data, network protocol data, data packet marking and classification data. The service corresponding to the DPU may also be an edge computing and Internet of Things application service. In this case, the data traffic includes sensor data, original device data, image and video data, text and voice data, position and movement data, etc.

As shown in FIG. 2, the DPU includes a system on chip (abbreviated as: SOC), a field programmable gate array (abbreviated as: FPGA), and a dynamic random-access memory (abbreviated as: DRAM).

In the embodiment of the present disclosure, the system on chip encapsulates a communication message (for example, a TCP message) to obtain the initial data read request. A specific encapsulation process is as follows: the system on chip first needs to establish a TCP connection with the storage cluster. The system on chip constructs parameters of a 4K data read request at an application layer, and encapsulates the parameters in the TCP message. A data part of the TCP message may include related information of the read request, such as a file name of the read file, a start position of the read file, and a length of the read data. Finally, the TCP/IP protocol header is encapsulated to obtain the initial data read request, that is, the TCP protocol header, including control information such as a source port number, a destination port number, a serial number, an acknowledgement number, and a window size, is added to the TCP message. The information is used to ensure reliable data transmission, flow control, and congestion control.

In the embodiment of the present disclosure, after generating the initial data read request, the system on chip transmits the initial data read request to the field programmable gate array through a PCIe bus. The field programmable gate array transmits the initial data read request to the storage cluster at the initial transmission rate at the first moment, where the initial transmission rate may be a transmission rate preset by the field programmable gate array.

In the embodiment of the present disclosure, after receiving the initial data read request, the storage cluster obtains corresponding data packages according to the initial data read request, assembles the data packages into the data traffic, and transmits the data traffic to the field programmable gate array. The field programmable gate array writes the received data traffic into the dynamic random-access memory.

In S12, the reliability indicator data corresponding to the data traffic is detected.

In the embodiment of the present disclosure, the reliability indicator data corresponding to the data traffic may be a packet loss rate within a unit time. A process of detecting the packet loss rate within the unit time may be: firstly, determining the total number of data packages corresponding to the data traffic within a unit time (for example, 1 ms). Specifically, the sending number of data packages corresponding to the data traffic in the transmission process may be acquired, and the sending number is used as the total number. Then, the number of lost data packages corresponding to the data traffic within the unit time (for example, 1 ms) is recorded. Finally, the packet loss rate is calculated according to the number of lost data packages and the total number.

A calculation formula of the packet loss rate within the unit time is: packet loss rate=(number of lost data packages/total number)×100%.

As an example, the total number of data packages corresponding to the data traffic within the unit time is 10. The number of lost data packages within the unit time is 3, and the packet loss rate is: ( 3/10)×100%=30%.

In S13, the reliability indicator data is analyzed to obtain the target adjustment strategy corresponding to the initial transmission rate.

In the embodiment of the present disclosure, the analyzing the reliability indicator data to obtain the target adjustment strategy corresponding to the initial transmission rate includes: comparing the packet loss rate within the unit time with a preset packet loss rate to obtain a comparison result; and determining an adjustment strategy corresponding to the comparison result as the target adjustment strategy.

In the embodiment of the present disclosure, the packet loss rate within the unit time is compared with the preset packet loss rate, so as to obtain the comparison result. Whether a packet loss occurs within the unit time is determined through the comparison result. Then, the corresponding adjustment strategy is determined according to the comparison result, and the transmission rate of the data read request at the next moment is adjusted through the adjustment strategy.

Specifically, if the comparison result is that the packet loss rate within the unit time is greater than or equal to the preset packet loss rate, it indicates that the packet loss occurs within the unit time. At this time, the storage cluster will reduce the transmission of data, resulting in a decline in the storage performance. If the data read request continues to be transmitted at the initial transmission rate within a short period of time, it will lead to network congestion, and the transmission data cannot be obtained in time. Therefore, when the comparison result is that the packet loss rate within the unit time is greater than or equal to the preset packet loss rate, the initial transmission rate needs to be reduced, so as to avoid network congestion and further ensure the storage performance of the storage cluster.

If the comparison result is that the packet loss rate within the unit time is less than the preset packet loss rate, it indicates that no packet loss occurs within the unit time, and at this time, it indicates that a network state is good. Therefore, when the comparison result is that the packet loss rate within the unit time is less than the preset packet loss rate, the initial transmission rate may be increased, thereby improving the data transmission efficiency.

In S14, the initial transmission rate is adjusted based on the target adjustment strategy to obtain the target transmission rate, so that the DPU transmits a data read request to the storage cluster at the target transmission rate at a second moment, where the second moment is a next moment of the first moment.

In the method provided in the embodiment of the present disclosure, the reliability indicator data of the data traffic fed back by the storage cluster on the basis of the data read request is detected, the adjustment strategy is determined according to the reliability indicator data, and the rate of transmitting the data read request to the storage cluster at the next moment is finally adjusted according to the adjustment strategy. In this way, the rate of transmitting the data read request by the DPU is dynamically adjusted according to the reliability indicator data, thereby avoiding network congestion. In addition, the rate of outputting the data traffic by the storage cluster can be indirectly controlled, thereby further ensuring the storage performance of the storage cluster.

In the embodiment of the present disclosure, the adjusting the initial transmission rate based on the target adjustment strategy to obtain the target transmission rate includes the following steps A1 to A2.

In A1, a first adjustment factor is acquired when the comparison result is that the packet loss rate within the unit time is greater than or equal to the preset packet loss rate, where the first adjustment factor is less than 1.

In the embodiment of the present disclosure, when the comparison result is that the packet loss rate within the unit time is greater than or equal to the preset packet loss rate, the rate of the data read request needs to be reduced. At this time, the preset first adjustment factor in the case of the packet loss may be acquired, and the first adjustment factor is less than 1, for example, the first adjustment factor may be 0.9.

In A2, a first product of the initial transmission rate and the first adjustment factor is calculated, and the first product is used as the target transmission rate.

As an example, the first adjustment factor is 0.9, and the initial transmission rate is P (Mbps). The target transmission rate is: 0.9×P (Mbps).

In the method provided in the embodiment of the present disclosure, when the packet loss rate is greater than or equal to the preset packet loss rate, the transmission rate of the data read request is reduced, so that network congestion can be avoided. In addition, by reducing the transmission rate of the data read request, the pressure on the storage cluster can be synchronously reduced, so that the storage cluster does not need to process the data read request at the original rate, thereby effectively ensuring the performance of the storage cluster and the stability of the storage cluster.

In the embodiment of the present disclosure, the adjusting the initial transmission rate based on the target adjustment strategy to obtain the target transmission rate includes the following steps B1 to B2.

In B1, a second adjustment factor is acquired when the comparison result is that the packet loss rate within the unit time is less than the preset packet loss rate, where the second adjustment factor is greater than 1.

In the embodiment of the present disclosure, when the comparison result is that the packet loss rate within the unit time is less than the preset packet loss rate, the rate of the data read request may be increased. At this time, the preset second adjustment factor in the case of no packet loss may be acquired, and the second adjustment factor is greater than 1, for example, the first adjustment factor may be 1.1.

In B2, a second product of the initial transmission rate and the second adjustment factor is calculated, and the second product is used as the target transmission rate.

As an example, the second adjustment factor is 1.1, and the initial transmission rate is P (Mbps). The target transmission rate is: 1.1×P (Mbps).

In the method provided in the embodiment of the present disclosure, when the packet loss rate is less than the preset packet loss rate, the rate of the data read request may be further increased, thereby improving the data transmission efficiency when the storage cluster has superior performance.

In the embodiment of the present disclosure, an implementation of acquiring the first adjustment factor is further provided. The implementation includes: detecting a target network condition of a communication link between the DPU and the storage cluster; and determining, based on a correspondence between network conditions and adjustment factors, an adjustment factor corresponding to the target network condition as the first adjustment factor.

Specifically, a network parameter of the communication link between the DPU and the storage cluster is detected, where the network parameter may be network bandwidth, network delay, etc. A data range in which the network parameter is located is queried, and a network condition corresponding to the data range is determined as the target network condition. The network condition may include: a stable condition, a fluctuating condition, a slow condition, etc. In order to quickly determine the adjustment factors corresponding to different network conditions, the embodiment of the present disclosure preset the correspondence between the network conditions and the adjustment factors. Therefore, when the packet loss rate within the unit time is greater than or equal to the preset packet loss rate, the target network condition of the communication link between the DPU and the storage cluster is directly detected. Then, the first adjustment factor corresponding to the target network condition is determined according to the above correspondence.

As an example, the network condition includes: a stable condition, a fluctuating condition, and a slow condition. An adjustment factor corresponding to the stable condition is MI, an adjustment factor corresponding to the fluctuating condition is M2, and an adjustment factor corresponding to the slow condition is M3. M1 is greater than M2, and M2 is greater than M3. Assuming that the initial transmission rate is P, M1 is 0.9, M2 is 0.8, and M3 is 0.7. Therefore, in the stable condition, the calculated target transmission rate may be 0.9P. In the fluctuating condition, the calculated target transmission rate may be 0.8P. In the slow condition, the calculated target transmission rate is 0.7P.

It should be noted that, in the method provided in the embodiment of the present disclosure, by setting the adjustment factors corresponding to different network conditions, the transmission rate of the data read request can be reduced more accurately, so that the reduced transmission rate will not further increase the pressure on the storage cluster, thereby ensuring the performance of the storage cluster.

In the embodiment of the present disclosure, an implementation of acquiring the second adjustment factor is further provided. The implementation includes: acquiring a current performance parameter of the storage cluster; and determining, according to the performance parameter, a cluster state corresponding to the storage cluster, and using an adjustment factor corresponding to the cluster state as the second adjustment factor.

Specifically, the current performance parameter of the storage cluster may be acquired, where the performance parameter includes: bandwidth, response time, input/output operations per second, throughput, and delay, etc. Then, the performance parameter of the storage cluster is analyzed to determine the current cluster state of the storage cluster, where the cluster state may be a healthy state, a loading state, a task execution state, etc.

As an example, an adjustment factor corresponding to the healthy state is N1, an adjustment factor corresponding to the loading state is N2, and an adjustment factor corresponding to the task execution state is N3. N1 is greater than N2, and N2 is greater than N3. Assuming that the initial transmission rate is P, N1 is 1.3, N2 is 1.2, and N3 is 1.1. Therefore, in the healthy state, the calculated target transmission rate may be 1.3P. In the loading state, the calculated target transmission rate may be 1.2P. In the task execution state, the calculated target transmission rate is 1.1P.

It should be noted that, by setting different adjustment factors corresponding to different cluster states, the corresponding adjustment factor can be selected to adjust the transmission rate according to the performance of the storage cluster in the case of no packet loss. The purpose is to transmit more data read requests in the current cluster state, and ensure that the transmitted data read requests will not cause a decline in the performance of the storage cluster.

The embodiments further provide an apparatus for controlling a data transmission rate based on a DPU. The apparatus is used to implement the above embodiments and preferred implementations, which will not be repeated. As used hereunder, the term “module” may refer to a combination of software and/or hardware for implementing a predetermined function. Although the apparatus described in the following embodiments is preferably implemented in software, the implementation in hardware or a combination of software and hardware is also possible and conceived.

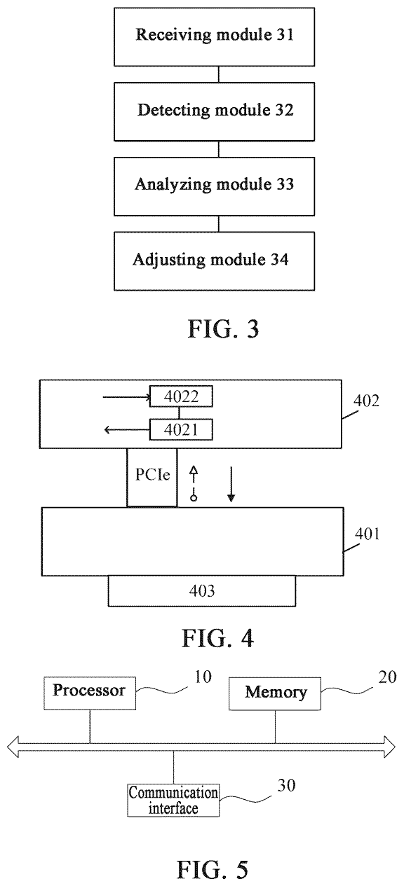

The embodiments provide an apparatus for controlling a data transmission rate based on a DPU. As shown in FIG. 3, the apparatus includes a receiving module 31, a detecting module 32, an analyzing module 33, and an adjusting module 34.

The receiving module 31 is configured to detect data traffic received by the DPU, where the DPU is configured to transmit an initial data read request to a storage cluster at a first moment at an initial transmission rate, and the data traffic is fed back by the storage cluster to the DPU after the initial data read request is received.

The detecting module 32 is configured to detect reliability indicator data corresponding to the data traffic.

The analyzing module 33 is configured to analyze the reliability indicator data to obtain a target adjustment strategy corresponding to the initial transmission rate.

The adjusting module 34 is configured to adjust the initial transmission rate based on the target adjustment strategy to obtain a target transmission rate, so that the DPU transmits a data read request to the storage cluster at the target transmission rate at a second moment, where the second moment is a next moment of the first moment.

In the embodiment of the present disclosure, the reliability indicator data includes a packet loss rate within a unit time.

In the embodiment of the present disclosure, the analyzing module 33 is configured to compare the packet loss rate within the unit time with a preset packet loss rate to obtain a comparison result; and determine an adjustment strategy corresponding to the comparison result as the target adjustment strategy.

In the embodiment of the present disclosure, the adjusting module 34 is configured to acquire a first adjustment factor when the comparison result is that the packet loss rate within the unit time is greater than or equal to the preset packet loss rate, where the first adjustment factor is less than 1; and calculate a first product of the initial transmission rate and the first adjustment factor, and use the first product as the target transmission rate.

In the embodiment of the present disclosure, the adjusting module 34 is configured to acquire a second adjustment factor when the comparison result is that the packet loss rate within the unit time is less than the preset packet loss rate, where the second adjustment factor is greater than 1; and calculate a second product of the initial transmission rate and the second adjustment factor, and use the second product as the target transmission rate.

In the embodiment of the present disclosure, the adjusting module 34 is configured to detect a target network condition of a communication link between the processor and the storage cluster; and determine, based on a correspondence between network conditions and adjustment factors, an adjustment factor corresponding to the target network condition as the first adjustment factor.

In the embodiment of the present disclosure, the adjusting module 34 is configured to acquire a current performance parameter of the storage cluster; and determine, according to the performance parameter, a cluster state corresponding to the storage cluster, and use an adjustment factor corresponding to the cluster state as the second adjustment factor.

An embodiment of the present disclosure provides a data processing unit (DPU). As shown in FIG. 4, the data processing unit (DPU) includes a system on chip 401 and a field programmable gate array 402. The system on chip 401 is connected to the field programmable gate array 402 through a bus. The field programmable gate array 402 includes a rate adapter 4021 and a regulator 4022.

The system on chip 401 is configured to generate a data read request, and transmit the data read request to the rate adapter 4021 in the field programmable gate array through the bus.

The rate adapter 4021 is configured to transmit the data read request to a storage cluster at an initial transmission rate at a first moment.

The regulator 4022 is configured to: receive a data traffic fed back by the storage cluster on the basis of the initial data read request; detect reliability indicator data corresponding to the data traffic; analyze the reliability indicator data to obtain a target adjustment strategy corresponding to the initial transmission rate; and adjust the initial transmission rate based on the target adjustment strategy to obtain a target transmission rate, so that the processor transmits a data read request to the storage cluster at the target transmission rate at a second moment, where the second moment is a next moment of the first moment.

In the embodiment of the present disclosure, the processor further includes a dynamic random-access memory 403. The dynamic random-access memory 403 is configured to store the data traffic.

FIG. 5 is a schematic diagram of a structure of an electronic device according to an optional embodiment of the present disclosure. As shown in FIG. 5, the electronic device includes: one or more processors 10, a memory 20, and interfaces for connecting various components, including a high-speed interface and a low-speed interface. The components communicate with each other through different buses, and may be installed on a public main board or installed in other manners as required. The processor may process instructions executed within the electronic device, including instructions stored in or on the memory to display graphic information of a GUI on an external input/output apparatus (such as a display apparatus coupled to the interface). In some optional implementations, multiple processors and/or multiple buses may be used together with multiple memories and multiple memories if required. Similarly, multiple electronic devices may be connected, and each device provides part of necessary operations (for example, as a server array, a group of blade servers, or a multi-processor system).

The processor 10 may be a central processing unit, a network processor, or a combination thereof. The processor 10 may further include a hardware chip. The hardware chip may be an application-specific integrated circuit, a programmable logic device, or a combination thereof. The programmable logic device may be a complex programmable logic device, a field programmable logic gate array, a generic array logic, or any combination thereof.

The memory 20 stores instructions executable by the at least one processor 10, so that the at least one processor 10 executes the method shown in the above embodiments.

The memory 20 may include a program storage area and a data storage area. The program storage area may store an operating system and applications required for at least one function. The data storage area may store data created according to the use of the electronic device for displaying the applet landing page. In addition, the memory 20 may include a high-speed random-access memory, and may also include a non-transitory memory, such as at least one disk storage device, a flash memory device, or other non-transitory solid-state storage devices. In some optional implementations, the memory 20 may optionally include a memory remotely provided relative to the processor 10, and these remote memories may be connected to the electronic device through a network. Examples of the network include but are not limited to the Internet, an intranet, a local area network, a mobile communication network, and combinations thereof.

The memory 20 may include a volatile memory, for example, a random-access memory; the memory may also include a non-volatile memory, for example, a flash memory, a hard disk, or a solid-state disk; the memory 20 may also include a combination of the above-mentioned types of memories.

The electronic device also includes a communication interface 30 for communicating with other devices or communication networks.

The embodiments of the present disclosure also provide a computer-readable storage medium. The method according to the embodiments of the present disclosure can be implemented in hardware, firmware, or computer code that can be recorded on a storage medium, or computer code originally stored in a remote storage medium or a non-transitory machine-readable storage medium and downloaded via a network and to be stored in a local storage medium, so that the method described herein can be stored in such software processing on a storage medium using a general computer, a dedicated processor, or programmable or dedicated hardware. The storage medium may be a magnetic disk, an optical disk, a read-only memory, a random-access memory, a flash memory, a hard disk, or a solid-state disk, etc.; further, the storage medium may also include a combination of the above-mentioned types of memories. It can be understood that a computer, a processor, a microprocessor, a controller, or programmable hardware includes a storage component that can store or receive software or computer code, and when the software or computer code is accessed and executed by the computer, the processor, or the hardware, the method shown in the above embodiments is implemented.

Although the embodiments of the present disclosure are described with reference to the drawings, persons of ordinary skill in the art may make various modifications and variations without departing from the spirit and scope of the present disclosure, and such modifications and variations all fall within the scope defined by the appended claims.

I/we claim:

1. A method for controlling a data transmission rate based on a Data Processing Unit (DPU), comprising:
detecting data traffic received by the DPU, wherein the DPU is configured to transmit an initial data read request to a storage cluster at a first moment at an initial transmission rate, and the data traffic is fed back by the storage cluster to the DPU after the initial data read request is received;
detecting reliability indicator data corresponding to the data traffic;
analyzing the reliability indicator data to obtain a target adjustment strategy corresponding to the initial transmission rate; and
adjusting the initial transmission rate based on the target adjustment strategy to obtain a target transmission rate, to cause the DPU to transmit a data read request to the storage cluster at a second moment at the target transmission rate, wherein the second moment is a next moment of the first moment.

2. The method according to claim 1, wherein the reliability indicator data comprises a packet loss rate within a unit time; and
analyzing the reliability indicator data to obtain the target adjustment strategy corresponding to the initial transmission rate comprises:
comparing the packet loss rate within the unit time with a preset packet loss rate to obtain a comparison result; and
determining an adjustment strategy corresponding to the comparison result as the target adjustment strategy.

3. The method according to claim 2, wherein adjusting the initial transmission rate based on the target adjustment strategy to obtain the target transmission rate comprises:
acquiring a first adjustment factor in response to the comparison result is that the packet loss rate within the unit time is greater than or equal to the preset packet loss rate, wherein the first adjustment factor is less than 1; and
calculating a first product of the initial transmission rate and the first adjustment factor, and using the first product as the target transmission rate.

4. The method according to claim 2, wherein adjusting the initial transmission rate based on the target adjustment strategy to obtain the target transmission rate comprises:
acquiring a second adjustment factor in response to the comparison result is that the packet loss rate within the unit time is less than the preset packet loss rate, wherein the second adjustment factor is greater than 1; and
calculating a second product of the initial transmission rate and the second adjustment factor, and using the second product as the target transmission rate.

5. The method according to claim 3, wherein acquiring the first adjustment factor comprises:
detecting a target network condition of a communication link between the DPU and the storage cluster; and
determining, based on a correspondence between network conditions and adjustment factors, an adjustment factor corresponding to the target network condition as the first adjustment factor.

6. The method according to claim 4, wherein acquiring the second adjustment factor comprises:
acquiring a current performance parameter of the storage cluster; and
determining, according to the performance parameter, a cluster state corresponding to the storage cluster, and determining an adjustment factor corresponding to the cluster state as the second adjustment factor.

7. An electronic device, comprising:
a memory and a processor, wherein the memory and the processor communicatively connected with each other, the memory stores computer instructions, when executed by the processor, cause the processor:
detect data traffic received by the DPU, wherein the DPU is configured to transmit an initial data read request to a storage cluster at a first moment at an initial transmission rate, and the data traffic is fed back by the storage cluster to the DPU after the initial data read request is received;
detect reliability indicator data corresponding to the data traffic;
analyze the reliability indicator data to obtain a target adjustment strategy corresponding to the initial transmission rate; and
adjust the initial transmission rate based on the target adjustment strategy to obtain a target transmission rate, to cause the DPU to transmit a data read request to the storage cluster at a second moment at the target transmission rate, wherein the second moment is a next moment of the first moment.

8. The electronic device according to claim 7, wherein the reliability indicator data comprises a packet loss rate within a unit time.

9. The electronic device according to claim 8, wherein the computer instructions causing the processor to analyze the reliability indicator data to obtain the target adjustment strategy corresponding to the initial transmission rate further cause the processor:
compare the packet loss rate within the unit time with a preset packet loss rate to obtain a comparison result; and
determine an adjustment strategy corresponding to the comparison result as the target adjustment strategy.

10. The electronic device according to claim 9, wherein the computer instructions causing the processor to adjust the initial transmission rate based on the target adjustment strategy to obtain the target transmission rate further cause the processor:
acquire a first adjustment factor in response to the comparison result is that the packet loss rate within the unit time is greater than or equal to the preset packet loss rate, wherein the first adjustment factor is less than 1; and
calculate a first product of the initial transmission rate and the first adjustment factor, and use the first product as the target transmission rate.

11. The electronic device according to claim 9, wherein the computer instructions causing the processor to adjust the initial transmission rate based on the target adjustment strategy to obtain the target transmission rate further cause the processor:
acquire a second adjustment factor in response to the comparison result is that the packet loss rate within the unit time is less than the preset packet loss rate, wherein the second adjustment factor is greater than 1; and
calculate a second product of the initial transmission rate and the second adjustment factor, and use the second product as the target transmission rate.

12. The electronic device according to claim 10, wherein the computer instructions causing the processor to acquire the first adjustment factor further cause the processor:
detect a target network condition of a communication link between the DPU and the storage cluster; and
determine, based on a correspondence between network conditions and adjustment factors, an adjustment factor corresponding to the target network condition as the first adjustment factor.

13. The electronic device according to claim 11, wherein the computer instructions causing the processor to acquire the second adjustment factor further cause the processor:
acquire a current performance parameter of the storage cluster; and
determine, according to the performance parameter, a cluster state corresponding to the storage cluster, and determine an adjustment factor corresponding to the cluster state as the second adjustment factor.

14. A non-transitory computer-readable storage medium, wherein the computer-readable storage medium stores computer instructions, when executed by a computer, cause the computer:
detect data traffic received by the DPU, wherein the DPU is configured to transmit an initial data read request to a storage cluster at a first moment at an initial transmission rate, and the data traffic is fed back by the storage cluster to the DPU after the initial data read request is received;
detect reliability indicator data corresponding to the data traffic;
analyze the reliability indicator data to obtain a target adjustment strategy corresponding to the initial transmission rate; and
adjust the initial transmission rate based on the target adjustment strategy to obtain a target transmission rate, to cause the DPU to transmit a data read request to the storage cluster at a second moment at the target transmission rate, wherein the second moment is a next moment of the first moment.

15. The non-transitory computer-readable storage medium according to claim 14, wherein the reliability indicator data comprises a packet loss rate within a unit time.

16. The non-transitory computer-readable storage medium according to claim 15, wherein the computer instructions causing the computer to analyze the reliability indicator data to obtain the target adjustment strategy corresponding to the initial transmission rate further cause the computer:
compare the packet loss rate within the unit time with a preset packet loss rate to obtain a comparison result; and
determine an adjustment strategy corresponding to the comparison result as the target adjustment strategy.

17. The non-transitory computer-readable storage medium according to claim 16, wherein the computer instructions causing the computer to adjust the initial transmission rate based on the target adjustment strategy to obtain the target transmission rate further cause the computer:
acquire a first adjustment factor in response to the comparison result is that the packet loss rate within the unit time is greater than or equal to the preset packet loss rate, wherein the first adjustment factor is less than 1; and
calculate a first product of the initial transmission rate and the first adjustment factor, and use the first product as the target transmission rate.

18. The non-transitory computer-readable storage medium according to claim 16, wherein the computer instructions causing the computer to adjust the initial transmission rate based on the target adjustment strategy to obtain the target transmission rate further cause the computer:
acquire a second adjustment factor in response to the comparison result is that the packet loss rate within the unit time is less than the preset packet loss rate, wherein the second adjustment factor is greater than 1; and
calculate a second product of the initial transmission rate and the second adjustment factor, and use the second product as the target transmission rate.

19. The non-transitory computer-readable storage medium according to claim 17, wherein the computer instructions causing the computer to acquire the first adjustment factor further cause the computer:
detect a target network condition of a communication link between the DPU and the storage cluster; and
determine, based on a correspondence between network conditions and adjustment factors, an adjustment factor corresponding to the target network condition as the first adjustment factor.

20. The non-transitory computer-readable storage medium according to claim 18, wherein the computer instructions causing the computer to acquire the second adjustment factor further cause the computer:
acquire a current performance parameter of the storage cluster; and
determine, according to the performance parameter, a cluster state corresponding to the storage cluster, and determine an adjustment factor corresponding to the cluster state as the second adjustment factor.
